(19) United States
(12) Patent Application Publication
(10) Pub. No.: US 2026/0317053 A1
(43) Pub. Date: Oct. 15, 2026

(54) BAG CONFIGURATION FOR PAIL

(71) Applicant: ANGELCARE CANADA INC., Montréal (CA)

(72) Inventor: Michel MORAND, Verdun (CA)

(21) Appl. No.: 19/116,568

(22) PCT Filed: Sep. 29, 2023
(86) PCT No.: PCT/CA2023/051294

§ 371 Date: Mar. 28, 2025

Related U.S. Application Data
(60) Provisional application No. 63/411,362, filed on Sep. 29, 2022.

(51) Int. Cl. B65F 1/00; B65D 33/00; B65F 1/06

(52) U.S. Cl. CPC B65F 1/0006; B65D 33/002; B65F 1/065; B65F 2250/105

(57) ABSTRACT

A bag adapted for use in a waste disposal unit having a bag support for hanging the bag opened and delimiting a central opening having a cross-sectional area CA, the bag support defining a hooking periphery HP along the central opening, a peripheral outline of HP is greater than that of CA, the bag having a tubular body, said body of the opened bag defining an internal volume for packing objects, the tubular body having a first section including a top open end, and at least a second section including a bottom closed end, the first section stretchable from an unstretched condition to a stretched condition, when the bag is opened: in the unstretched condition, the first section has an open cross-sectional area smaller than the cross-sectional area CA, and in the stretched condition, the open cross-sectional area is at least equal to the cross-sectional area CA.

### CROSS-REFERENCE TO RELATED APPLICATION(S)

The present application claims priority of United Stated Patent Application Ser. No. 63/411,362, filed on Sep. 29, 2022, the entire content of which is incorporated herein by reference.

### TECHNICAL FIELD

The present application pertains to bags and bag rolls as used in waste-disposal units, such as garbage cans, pails, composts, etc.

### BACKGROUND OF THE ART

Disposal units, such as garbage cans, pails, composts, recycling bins are conventionally configured to support a bag. For convenience and cost-effective packaging, the bags are commonly part of a bag roll, with the bags interconnected one to another. In a particular configuration, bag rolls are stored in a bottom of a pail or wire rack, and a free end of the bag roll is raised to be supported open at a top end of the pail or wire rack. Accordingly, when a bag is full of waste or other items, the filled bag may be removed for the next bag in the roll to be deployed for receiving waste. However, as bags are filled with waste, they increase in volume and may be hard to remove from a pail or wire rack, especially if the filled bags are to be pulled upwardly out of the pail. Additionally, conventional bags may not uniformly fit and/or be firmly maintained opened on specific disposal units.

### SUMMARY

It is an aim of the present disclosure to provide a novel bag, bag roll and/or cassette for dispensing waste bags.

In accordance with an aspect, there is provided a bag adapted for use in a waste disposal unit, the waste disposal unit having a bag support for hanging the bag opened, the bag support delimiting a central opening for receiving the bag, the central opening having a cross-sectional area CA, the cross-sectional area CA having a first maximum dimension WD and a second maximum dimension DD normal to the first maximum dimension WD, with DD at least 70% of WD, the bag support defining a hooking periphery HP along the central opening, wherein a peripheral outline of HP is greater than a peripheral outline of CA, and a waste receiving volume having a heightwise dimension UH extending from the bag support to a bottom of the disposal unit, the bag comprising: a tubular body with a top open end and a bottom closed end, the tubular body of the opened bag defining an internal volume for packing objects, the tubular body having a first section including the top open end, and at least a second section including the bottom closed end, the first section being stretchable from an unstretched condition to a stretched condition, wherein when the bag is opened: in the unstretched condition, the first section having an open cross-sectional area smaller than the cross-sectional area CA, and in the stretched condition, the open cross-sectional area is at least equal to the cross-sectional area CA.

Further in accordance with the above aspect, for example, the second section has an open cross-sectional area being at most 0.95 CA.

Further in accordance with the above aspects, for example, the tubular body has a length L extending from the top open end to the bottom closed end, the length L greater than the heightwise dimension UH.

Further in accordance with the above aspects, for example, the length L is in accordance with 1.05UH≤L≤1.25UH.

Further in accordance with the above aspects, for example, the tubular body in a flattened two-fold condition has a pair of side edges extending from a top edge in a direction of a bottom edge, the top edge delimiting the top open end, the bottom edge delimiting the bottom closed end, wherein the top open end has a flattened two-fold width WA in accordance with 0.9 POL/2≤WA<POL/2, where POL is defined as an outline of the hooking periphery HP.

Further in accordance with the above aspects, for example, the side edges are parallel from the top open end to the bottom closed end.

Further in accordance with the above aspects, for example, the tubular body in a flattened two-fold condition has a pair of side edges extending from a top edge in a direction of a bottom edge, the top edge delimiting the top open end, a weld seam extending from at least one of the side edges to the bottom closed end and forming a taper in the second section, the taper causing a reduction of open cross-sectional area of the bag in the second section.

Further in accordance with the above aspects, for example, the bag further comprises a flap adjacent to the weld seam, the flap extending between the weld seam and one of the side edges.

Further in accordance with the above aspects, for example, the tubular body is made of at least two layers of film.

Further in accordance with the above aspects, for example, the first section and the second section are made of a film of compostable material.

In accordance with another aspect, there is provided a bag adapted for use in a waste disposal unit, the waste disposal unit having a bag support for hanging the bag opened, the bag support delimiting a central opening of the waste disposal unit and having a cross-sectional area CA, the cross-sectional area CA having a first maximum dimension WD and a second maximum dimension DD normal to the first maximum dimension WD, with DD at least 70% of WD, the bag support defining a hooking periphery HP along the central opening, wherein a peripheral outline of HP>a peripheral outline of CA, and a waste receiving volume having a heightwise dimension UH extending from the bag support to a bottom of the disposal unit, the bag comprising: a tubular body with a top open end and a bottom closed end, the tubular body of the bag openable to define an internal volume accessible via the top open end, the tubular body having a first section including the top open end, and at least a second section including the bottom closed end, the first section being stretchable from an unstretched condition to a stretched condition, wherein the first section in an unstretched condition has an open cross-sectional area being at most 0.95CA; wherein the first section in a stretched condition has an open cross-sectional area being at least equal to that of HP without tearing.

Further in accordance with the above aspect, for example, the second section has an open cross-sectional area being at most 0.95CA.

Further in accordance with the above aspects, for example, the tubular body has a length L extending from the top open end to the bottom closed end, and the length L is in accordance with 1.05UH ≤L≤1.25UH.

Further in accordance with the above aspects, for example, the tubular body in a flattened two-fold condition has a pair of side edges extending from a top edge in a direction of a bottom edge, the top edge delimiting the top open end, the bottom edge delimiting the bottom closed end, wherein the top open end has a flattened two-fold width WA in accordance with 0.9 POL/2≤WA<POL/2, where POL is defined as an outline of the hooking periphery HP.

Further in accordance with the above aspects, for example, the tubular body in a flattened two-fold condition has a pair of side edges extending from a top edge in a direction of a bottom edge, the top edge delimiting the top open end, a weld seam extending from at least one of the side edges to the bottom closed end and forming a taper in the second section, the taper causing a reduction of open cross-sectional area of the bag in the second section.

Further in accordance with the above aspects, for example, the bag further comprises a flap adjacent to the weld seam, the flap extending between the weld seam and one of the side edges.

Further in accordance with the above aspects, for example, the first section is stretchable in a plastic deformation range from the unstretched condition to the stretched condition to gain the cross-sectional area of the top open end at least equal to that delimited by the hooking periphery HP, without tearing.

Further in accordance with the above aspects, for example, the first section is stretchable in the plastic deformation range to gain, in the stretched condition, a cross-sectional area HPA delimited by the hooking periphery HP in accordance with 1.01CA≤HPA≤1.2CA.

In accordance with another aspect, there is provided a bag adapted for use in a waste disposal unit, the waste disposal unit having a bag support for hanging the bag opened, the bag support delimiting a central opening for receiving the bag and a hooking periphery HP extending along the central opening, the central opening having a cross-sectional area CA having a first maximum dimension WD and a second maximum dimension DD normal to the first maximum dimension WD, with DD at least 70% of WD, the bag comprising: a tubular body with a top open end and a bottom closed end, the tubular body of the opened bag defining an internal volume for packing objects, the internal volume reducing longitudinally between the top open end and the bottom closed end; the tubular body stretchable transversely to expand the top open end, the tubular body having a first section including the top open end, and a second section including the bottom closed end, the first section having a width in a flattened two-fold condition and an elongation at break in a peripheral direction selected so as to have in an unstretched condition an open cross-sectional area between 90% and 100% of the cross-sectional area CA.

Further in accordance with the above aspect, for example, the waste disposal unit has a waste receiving volume having a heightwise dimension UH extending from the bag support to a bottom of the disposal unit, the bag has a length L extending from the top open end to the bottom closed end, the length L is in accordance with 1.05UH≤L≤1.25UH.

Further in accordance with the above aspects, for example, the first section is stretchable in a plastic deformation range from the unstretched condition to a stretched condition in which the open cross-sectional area of the top open end is at least equal to that delimited by the hooking periphery HP, without tearing.

In accordance with another aspect, there is provided a bag roll comprising: a plurality of the bag according to any one of the preceding aspects, wherein the bags are connected end to end and from a bottom edge of a first of the bags in the bag roll, to a top edge of a second of the bags in the bag roll.

In accordance with another aspect, there is provided a bag dispensing cassette comprising a tubular film defining a plurality of bags as defined in any one of the preceding aspects, and a receptacle enclosing at least part of the plurality of bags, the plurality of bags connected end to end and from the bottom edge of a first one of the bags, to the top edge of a second one of the bags, the tubular film accumulated in a fanfold or multifold configuration.

In accordance with another aspect, there is provided a method for installing a bag in a pail, comprising: positioning a closed end of a bag in a pail through a central opening in the pail; deforming a top end of the bag from an unstretched condition to hook the bag onto a bag support at a top end of the pail, such that the top end of the bag is open; and depositing waste in the bag via the top open end, a weight of the waste being supported by the pail via the closed end of the bag being seated against a bottom of the pail.

Further in accordance with the above aspect, for example, deforming the top end of the bag from the unstretched condition includes deforming the top end of the bag in a plastic deformation range.

Further in accordance with the above aspects, for example, deforming the top end of the bag from the unstretched condition includes deforming the bag at separate locations corresponding to separate hooking members of the pail.

### DESCRIPTION OF THE DRAWINGS

FIG. 1 is a perspective view of a bag roll in accordance with an embodiment of the present disclosure;

FIG. 2 is a perspective view of a bag dispensing cassette in accordance with the present disclosure, including for instance the bag roll of FIG. 1;

FIG. 3 is a perspective view of the bag dispensing cassette of FIG. 2 in a fragmented waste-disposal unit;

FIG. 4 is a sectional view of the bag dispensing cassette and waste-disposal unit of FIG. 3;

FIG. 4A is a perspective view of a bag support of the waste-disposal unit of FIG. 3, according to a variant;

FIGS. 5A to 5C are plan views of top edge outlines for bags of the bag roll of FIG. 1;

FIG. 6 is a perspective view of a bag roll such as in FIG. 1, in accordance with another embodiment of the present disclosure; and

FIG. 7 is a perspective view of a film-dispensing cassette with bags such as in the bag roll of FIGS. 1 and 6, in another accumulated configuration.

### DETAILED DESCRIPTION

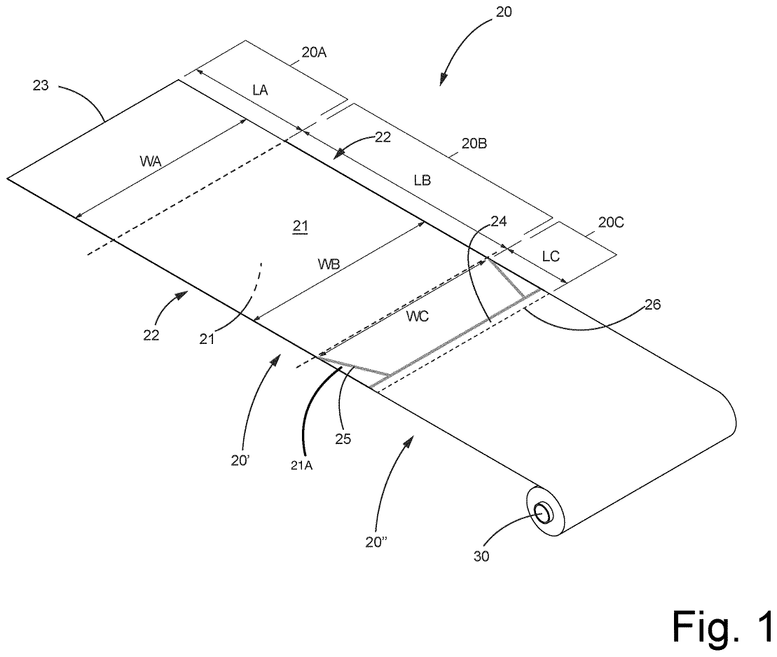

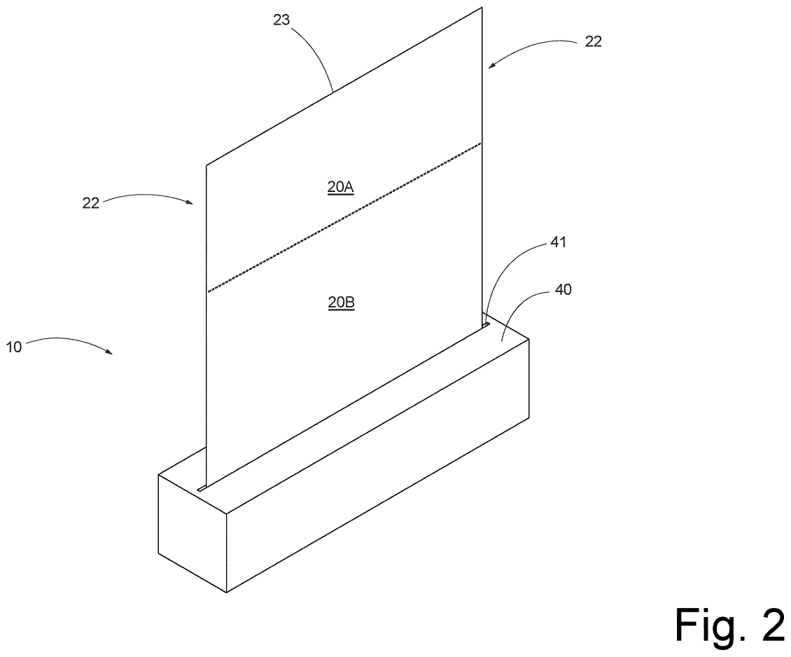

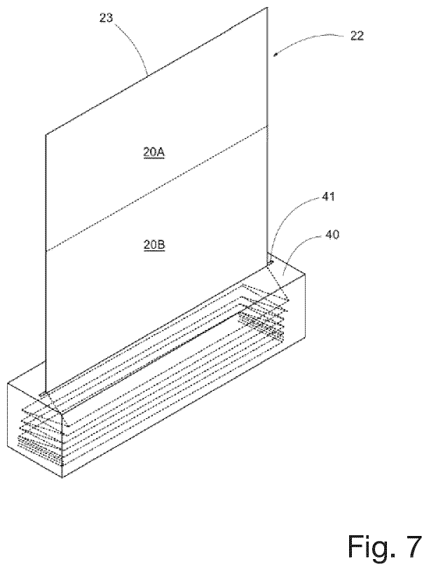

Referring to the drawings and more particularly to FIGS. 1 and 2, a bag dispensing cassette is generally shown at 10 (FIG. 2). The bag dispensing cassette 10 may have a bag roll 20, rolled onto a tube 30 (as shown in FIG. 1) or rolled onto itself (i.e., no tube), and inserted into a cassette body 40. The bag roll 20 in accordance with the present disclosure may also be with or without the tube 30 and/or the cassette body 40. While the figures show a bag roll 20, the bags of any of the figures may be provided individually, i.e., not part of a roll, or in a zig-zag pattern (fanfold), such as a continuous bagging film arranged in a fanfold condition (FIG. 7). While the term bag roll is used herein for simplicity, any description related to the bags in the form of a bag roll may similarly apply to a bagging film not in a roll, such as in a fanfold condition.

The bag roll 20 is shown in greater detail in FIG. 1. In at least some embodiments, the bag roll 20 may be made of a film or films of biodegradable and/or compostable material, such as starch-based or plant-based materials. For example, depending on the contemplated use and/or waste to be disposed of (e.g., kitchen waste, leftovers, ripened food), the film material may include bio-composites, including combinations of at least some of: cellulose fibers, lignocellulosic fibers, hemicellulose, lignin, pectin, polylactic acid (PLA), poly hydroxyalkanotes (PHA), and poly(ε-caprolactone) (PCL), as some possibilities. Other film material may be contemplated, such as non biodegradable and/or non compostable material. For example, in some embodiments the film material may include plastics such as polyethylene (LDPE, LLDPE or HDPE), bioplastics, polylactic acid, to name a few of numerous possible materials. It may also be contemplated to add functional layers, such as ethylene vinyl alcohol (EVOH), for the film to form an odor barrier, a nylon layer to reinforce the bag, or a natural fibers layer forming a moisture/fluid barrier. In some embodiments, portions of the bag roll 20 may be made of different materials, such as different biodegradable and/or compostable or plastic materials, whereby different mechanical properties (e.g. different levels of stretchability, elastic modulus, tensile strength, elongation at break, etc.), chemical properties (e.g., fluid impermeability/permeability, such as gas impermeability or liquid impermeability, etc.) and/or other properties as those set forth above may be obtained at selected locations/sections along the bag roll 20, lengthwise and/or widthwise. However, in at least some embodiments, these properties may be uniform (or substantially uniform, i.e., within a 10% margin) along the bag roll 20 and/or sections of the bag roll 20 defining respective bags 20′, which are described herein below.

The bag roll 20 may be in the form of a length of tubular film, with weld lines and tear-off perforations delimiting a plurality of bags interconnected end to end, as shown as 20′, 20″ and so on. The tubular film may be accumulated on a roll, in a zig-zag pattern, etc. The bag roll 20 may consequently appear to be a continuous sheet as in FIG. 1 due to the thinness of the film, though the bag roll 20 has a pair of panels 21 overlaid onto one another, and joined at side edges 22. In an embodiment, this is referred to as a flattened two-fold condition of the bags: the bags have two folds, i.e., one at each side edge 22, and no gusset. The side edges 22 may therefore be folds and not weld seams. Although the bags in the bag roll 20 could have gussets in accordance with the present disclosure, the transverse dimensions of the bag may be described herein as being in the flattened two-fold condition. This may be construed as meaning that, even if the bag roll 20 has gussets, the dimensions are for the transverse dimensions of the bag as if it were in a flattened two-fold condition. Even though the bags described herein may not be packaged or sold in the flattened two-fold condition (it may have even more folds, e.g., folded on itself), the flattened two-fold condition is the condition in which the bags are laid flat on a surface so as to have two lateral folds—two side edges—, between the top edge and the bottom edge. Moreover, reference is made to the bag as being unstretched or in an unstretched condition. This may be construed as meaning that the bags are in their initial condition on the bag roll 20 prior to having a user handle the bags to install same on a disposal unit, which installation may entail some elastic deformation and/or plastic deformation. The bags in their initial condition on the bag roll 20 may have been plastically prestretched in manufacturing, but in spite of such prestretching their condition on the bag roll 20 is said to be unstretched.

The side edges 22 of each bag extend from a top edge 23 to a bottom edge 24 of each bag, such as bag 20′. In the end-to-end connection of the bag roll 20, the bags are interconnected such that a bottom edge 24 of a leading bag is connected to a top edge 23 of a trailing bag in the bag roll 20, in contrast to bag rolls in which bottom edges or top edges of adjacent bags are interconnected. When laid flat, i.e., in a flattened two-fold condition, the bags 20′, 20″, etc, of the bag roll 20 have a constant width. For example, as shown, the side edges 22 are parallel to one another on the full length of the bags from the bag roll 20. However, it is also considered to provide a taper in the bags, from the top edge 23 to the bottom edge 24.

In a variant, the bags may have two, three or more distinct sections. The bags may also be without any such distinct section. As shown, each bag, such as bag 20′, has a top section 20A, which may be referred to as a hooking section, a middle section 20B, which may be referred to as a disposal section and a bottom section 20C, which may be referred to as a closed end section. As shown, the top section 20A, middle section 20B and bottom section 20C extend sequentially from the top edge 23 to the bottom edge 24, here without separation lines. The middle section 20B and the bottom section 20C may be considered as one continuous section including a bottom end of the bag 20′, for instance when dimensions and/or properties of these sections are the same from the top section 20A to the bottom end of the bag 20′. In other words, the middle section 20B and the bottom section 20C may have identical features one relative to the other when it comes to their stretchability and/or dimensions, e.g. width, or other properties, hence they may be considered as a single section of the bag 20′.

In the embodiment shown in FIG. 1, the bags 20′, 20″ are without tapering from the top edge 23 to the bottom edge 24. The top section 20A transitions directly to the middle section 20B without width reduction. There may be a constriction (bottleneck) section between the top section 20A and the middle section 20B in some variants.

In the depicted embodiment, the bags of the bag roll 20 are straight from the top edge 23 to the bottom edge 24, with a constant width. For clarity, the width described herein is the flat width as in FIG. 1, i.e., with the bags of the roll in a flattened two-fold condition with the panels 21 coplanar. Though the moniker “straight” is used in this context, the side edges may taper. The expression “straight” is used herein for differentiating purposes, in a non-limitative manner. For instance, in other embodiments, the side edges 22 at the top section 20A, although shown as straight and parallel in the embodiment of FIGS. 1 and 2, may taper toward the bottom edge 24 while still being considered “straight”. Likewise, the side edges 22 at the middle section 20B, although shown as straight and parallel in the embodiment of FIGS. 1 and 2, may taper toward the bottom edge 24 while still be considered “straight”. As yet other embodiments, the side edges 22 may taper continuously from the top edge 23 to the bottom edge 24, at a continuous angle, or with two (or more) different angles, i.e., one for section 20A, another for section 20B, and yet another for section 20C. In another embodiment, the bag 20′ (whether or not part of the roll 20) has the side edges 22 at the top section 20A parallel or quasi-parallel to one another, to then taper beyond the top section 20A, though the taper is optional.

The top section 20A has a width WA and the middle section 20B has a width WB, with the widths WA and WB substantially constant throughout most or all of the sections 20A and 20B, respectively, in a flattened two-fold condition, prior to installation of the bag. The side edges 22 in the top section 20A and the middle section 20B are parallel as in FIG. 1. If the sections 20A and 20B taper toward the bottom edge 24, such as in some variants, the top section 20A may have a minimum width WA that is greater than the mean width WB taken along the middle section 20B. For example, the width ratio is as follows: 0.60WA≤WB(mean)≤0.99WA. In another embodiment, the width ratio is as follows 0.65 WA≤WB(mean)≤0.85WA. However, in an unstretched configuration, as shown in FIG. 1, WA and WB may be equal.

The bags, such as bag 20′, have a length (L) that may be segmented as LA, LB and LC, to be representative of the height of sections 20A, 20B and 20C, respectively, if there are distinct sections 20A, 20B, 20C, which may not be the case in any of the embodiments described herein. In use with a waste disposal unit, the top section 20A may not extend below the bag support 56, with waste or other objects inside the bag 20′ being essentially in the volume of the bag defined by either one or both of the middle section 20B and bottom section 20C. In accordance with an embodiment, LB is at least 3 times the length of LA, i.e., LB>3LA. Stated differently, the length LA may be smaller than a third of the length LB. In an embodiment, such relative dimensions of LA and LB may correspond to having the length LA between 5% and 20% that of the length LB (or LB+LC). In a particular embodiment, the length LA is between 5% and 10% of the length LB (or LB+LC). In accordance with another embodiment including the bottom section 20C, LB+LC is at least 3 times the length LA, LB+LC>3LA. The length LA may be relatively small with respect to LB and/or LB+LC. These relative dimensions of the sections 20A, 20B and 20C of the bag 20′ may be of particular relevance when, for example, one section is designed to stretch more or less than other sections, as in some variants of the bag 20′ described herein. However, in embodiments where stretching properties are uniform along the length of the bag 20′ and where dimensions of the bag 20′ or internal volume ZZ (described later) are constant, such length segments LA, LB and LC may be only virtually present.

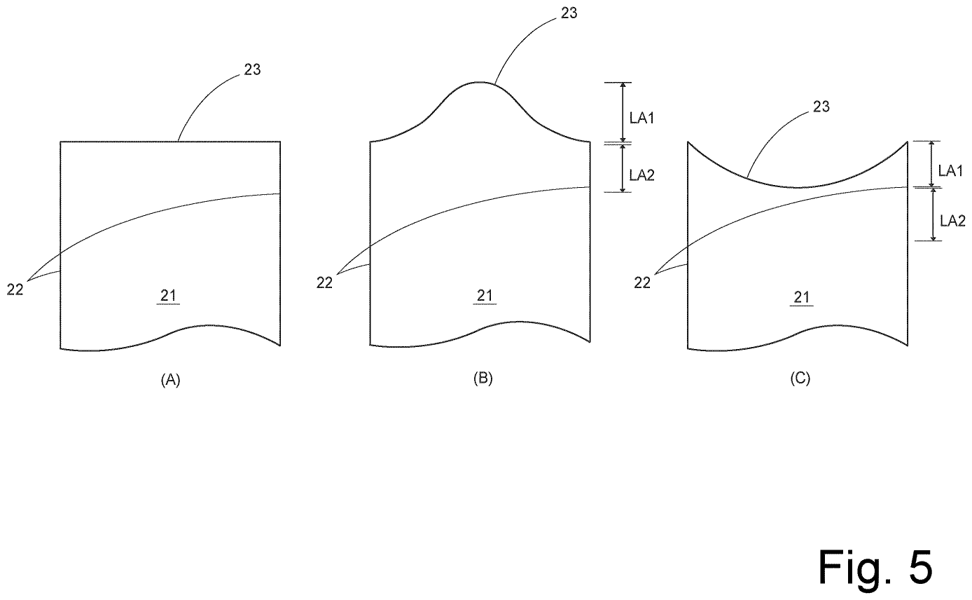

LA may be separated into LA1 and LA2 if the top edge 23 defines a concavity or convexity as detailed below. LA2 is the portion of the section 20A below such concavity or convexity (FIGS. 5B and 5C).

Referring to FIGS. 1 and 5A to 5C, the top edge 23 may have different outlines. In FIG. 1, the outline of the top edge 23 is a straight outline. Exemplary outlines are shown in FIGS. 5A to 5C, such as (A) a straight outline, (B) a convex sine waveform outline, (C) a concave arc outline. As the bags of the roll 20 are a pair of overlaid panels 21 as in FIG. 1 when in the optional two-fold flattened condition, when the panels 21 are separated from one another to open the bag at the top edge 23, the non-straight outlines of FIGS. 5B and 5C, each form a pair of flaps that may be used to form a knot to attach the bag closed. As the bags are interconnected end to end in the bag roll 20 with adjacent bags connected bottom to top as described above, the bottom edge 24 has a shape that is complementary to the top edge 23. Stated differently, if the outline of the top edge 23 is a concave sine waveform, the bottom edge 24 is a convex sine waveform, etc.

As shown in FIG. 1, a weld seam (or simply “seam”) 25 extends from one of the side edges 22 to the other to connect the panels 21. The weld seam 25 may be created by any appropriate welding or adhering method, such as heat welding, etc, whereby reference is made herein as a weld seam, although other types of jointing is contemplated, such as gluing. As shown, the weld seam 25 includes a portion that defines the bottom closed end of the bags 20′, 20″, etc.

In the embodiment of FIG. 1, the side edges 22 of the top section 20A and of the middle section 20B are the two folds in the tubular film as described above for the flattened two-fold condition, the folds defining a boundary between the panels 21. In FIG. 1, the bottom section 20C includes weld seams 25 extending at an angle from the weld seam 25 extending along the bottom edge 24 to the side edges 22. For simplicity, the expression “weld seams 25” may be used in the plural, though a single continuous weld seam 25, including a plurality of connected portions may be present. When the weld seams 25 define a taper as in FIG. 1, the section 20C with such taper has a length LC that is a fraction of the length LB, e.g., 5LC<LB, for instance so as not to reduce the internal volume of the bag excessively.

In the depicted embodiment, when laid flat, i.e., in a flattened two-fold condition, the bags 20′, 20″, etc, of the bag roll 20 have a constant width. For example, the side edges 22 are parallel to one another on the full length of the bags from the bag roll 20. However, due to the presence of one or two of the weld seams 25 in the bottom section 20C inwardly offset from the edge segment of the bottom section 20C, in one embodiment as the weld seams 25 are optional, the dimension of the inside of the bag at WC—for instance in terms of internal diameter/internal volume—reduces in the bottom section 20C. As shown, in the bottom section 20C, the weld seams 25 define a tapering section, i.e. a reduction of the internal diameter/volume of the bag, towards the bottom edge 24. Such reduction of the internal diameter/volume defines a convergence of the weld seams 25 in the bottom section 20C towards the weld seam 25 extending along the bottom edge 24 the bags, such as shown on bag 20′. The tapering of the internal diameter/volume of the bags in the bottom section 20C may eliminate (at least limit) a propensity of the waste inside the bags to accumulate in bottom corners of the bags, if the bottom section 20C had no tapering. At least in some instances, accumulation of waste in such bottom corners may hinder the removal of the bag packed with waste through the top of a disposal unit (detailed below). However, such tapering with weld seams 25 in the bottom section 20C is optional. Such tapering could also extend from the top edge 23 to the bottom edge 24, whereby the internal volume of the bag 20′ may reduce longitudinally from the top edge 23 of the bag 20′ to the closed end of the bag 20′.

In embodiments where the weld seams 25 are present, as in FIG. 1, flaps are formed to the exterior of weld seams 25 in the bottom section 20C. As shown, the weld seams 25 (or the portions of the continuous weld seam 25) extend angularly with respect to the side edges 22 of the bottom section 20C to form the tapering of the inside open diameter thereby defining flaps. As seen, triangular shaped flaps 21A extend between the weld seams 25 and the side edges 22 in the bottom section 20C of the bag 20′. The flaps may have other shapes such as curved chevron, etc. There may be a single side portion for the weld seam 25 (i.e., only one extending along one side edge 22 of the bottom section 20C) as opposed to the two side portions shown in the figures, and yet achieve the narrowing described herein. The bag 20′ of FIG. 1—or of all figures—may also come as individual units, i.e., not as part of a bag roll.

Therefore, in accordance with an embodiment, the weld seam 25 is made periodically in a straight continuous tube—a continuous tubular body—in a flattened two-fold condition. In at least some embodiments, such as shown, the weld seams 25 define the closed bottom end of the bags, and a tapering inside dimension in the bottom section 20C of the bags. In some embodiments, the weld seam(s) 25 may extend along one of the middle edge segment 22B while the other middle edge segment 22B is defined, partially or entirely, by a fold, as described above for the flattened two-fold condition. This may apply similarly to the side edge 22 segment in the top section 20A. In some other embodiments, the weld seam(s) 25 may extend along both side edges 22 (i.e. in the top section 20A and/or middle section 20B). The weld seam(s) 25 may extend to the top edge 23, or to the top section 20A, as different possibilities.

Tear-off perforation lines 26 are punctured at the junction between the bottom edge 24 of a first bag, the leading bag such as 20′, and the top edge 23 of the subsequent bag in the bag roll 20, the trailing bag such as 20″. The tear-off perforation line 26 may be defined by a series of spaced-apart punctures along an outline emulating that of the bottom edge 24 and the top edge 23. The tear-off perforation line 26 is adjacent to the weld seam 25, and forms a weakened portion of the bag roll 20, causing a separation of one of the bags, such as 20′ in FIGS. 1 and 2, as a result of a tearing action. As shown, the tear-off perforation line 26 at a junction between a leading bag and a trailing bag, such as bag 20′ and bag 20″, is offset from the weld seam 25 extending along the bottom edge 24. A band of material extending between the bottom edge 24 and the tear-off perforation line 26 may be referred to as a flap, as discussed above. In some embodiments, such flap between the bottom edge 24 and the tear-off perforation line 26 may be absent, or minimal. This may be the case where the tear-off perforation lines, such as at 26, are aligned or quasi-aligned with the weld seams 25 forming the closed bottom end of the bags, for instance. In an embodiment, the tear-off perforation lines 26 and cut outs at the sides of the weld seams 25 are done by die cutting. In FIG. 1, the dotted lines between sections 20A and 20B, and between 20B and 20C, are not perforation lines, and are merely present in the figures as imaginary lines to distinguish between the sections 20A, 20B and 20C (if the bag 20 has such sections).

Referring to FIG. 2, the bag roll 20 may optionally be inserted into a cassette body 40, being for example a receptacle from the bag roll 20. The cassette body 40 may have a slit 41 or like opening, such as a top opening, through which a free end of the bag roll 20 extends. The cassette body 40 is shown as having a cuboid geometry, although other shapes are considered as well, such as a rectangular prism, a cylinder, etc.

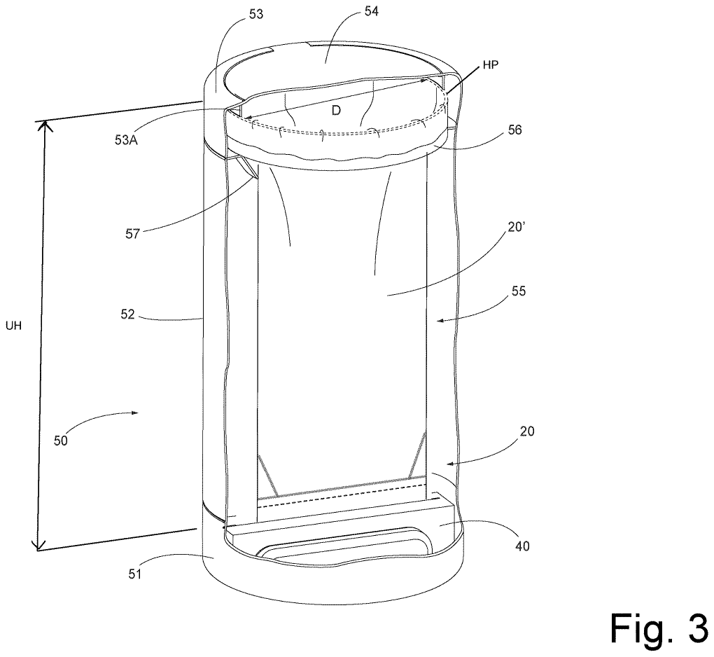

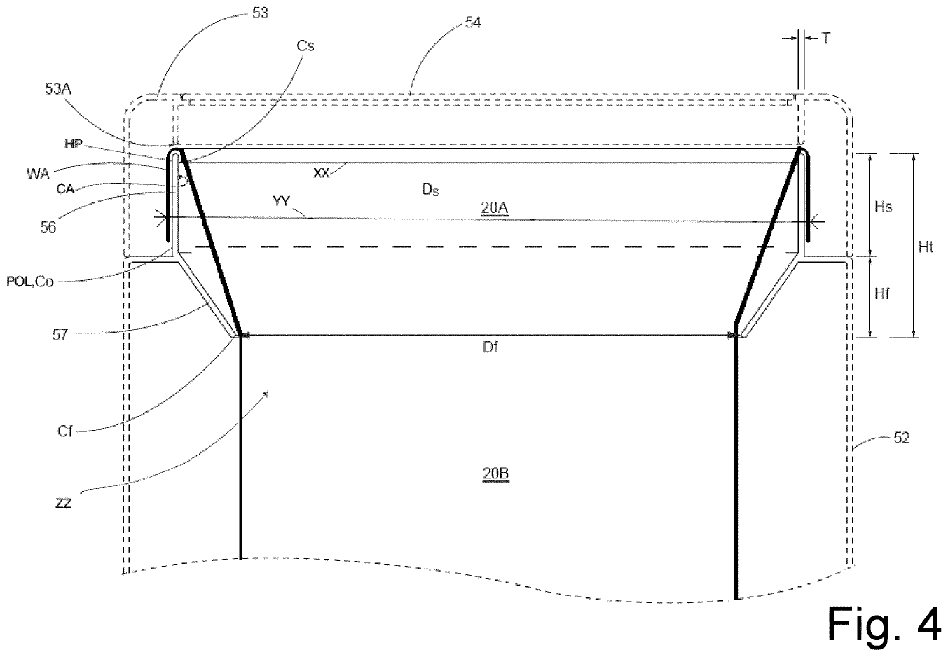

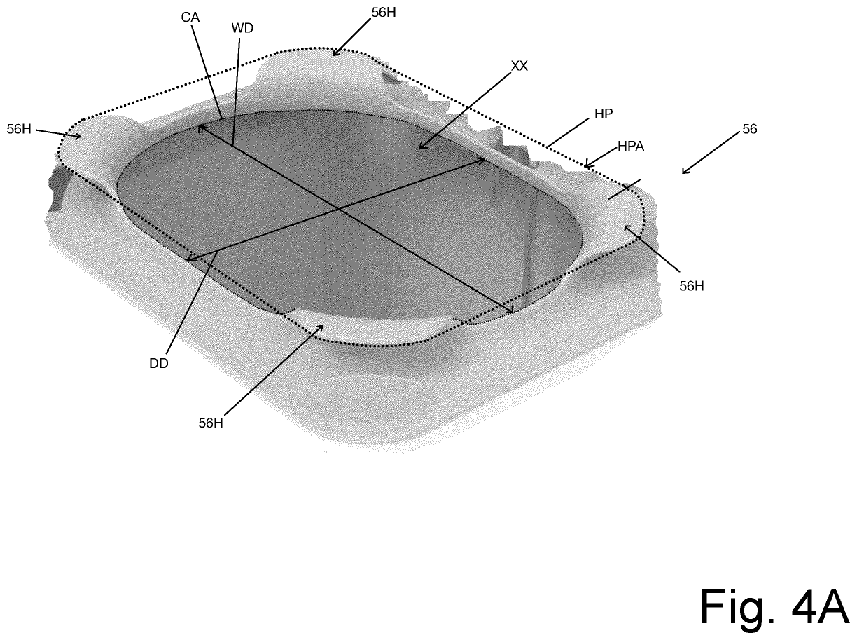

Referring now to FIGS. 3 and 4, the bag roll 20 as part of the cassette 10 (FIG. 2), as a bag roll 20 alone (FIG. 1), i.e., without the cassette body 40, or as an individual bag 20′, is received in a disposal unit 50. The expression “disposal unit” is used herein as encompassing a garbage, a diaper pail, a compost, a recycling bin, a litter pail, etc. The disposal unit 50 may have a base 51, upon which projects an upstanding wall(s) 52. The upstanding wall 52 is in the form of a tube (i.e., annular), which is circular in FIG. 3, but may have other shapes, with for example a square section, an oval section, etc. Although not shown, a hinged door may be part of the upstanding wall 52 to provide access to an interior of the disposal unit 50. As another possibility, the upstanding wall 52 may be raised out of engagement with the base 51. Various connection configurations may be present, such as quick connect mechanisms, fasteners, etc. A cover 53 is mounted atop the upstanding wall 52. The cover 53 may define a central opening with a downwardly projecting rim 53A that may come into close proximity or in contact with a bag to ensure the bag remains hung to the disposal unit 50, as in FIG. 4. Moreover, the central opening of the cover 53 shown in FIG. 3 may be shut closed by a trap door 54 (also known as lid), hinged to a remainder of the cover 53. 53A The trap door 54 opens or closes the top access to an inner cavity 55 of the disposal unit 50. It may be biased by a spring, or operated by a pedal mechanism, etc. Also, although not shown, a closing mechanism of any appropriate form (translation, rotation) may be provided in the inner cavity 55 or other location on the disposal unit 50 to squeeze the bag shut.

The disposal unit 50 has a bag support 56 adjacent to the cover 53. In an embodiment, the bag support 56 may have any appropriate shape, and is shown as being cylindrical, with a circular cross-section. Other possible cross-sectional shapes include, non-exhaustively, square, rectangular, oval, squircle, pentagon, hexagon, octagon, etc. Accordingly, the expression “tubular”, if referring to bag support as a tubular bag support covers these multiple shapes.

The bag support 56 delimits a central opening XX for receiving the bag 20′. The central opening XX defined by the bag support 56 has a cross-sectional area CA. The cross-section area CA may have any appropriate outline, such as circular, squircle, oval, etc, to name just a few of the possible outlines of the cross-section area CA. The bag support 56 defines a hooking periphery HP extending along the central opening XX to secure the top section 20A of the bag 20′ in the disposal unit 50. The bag 20′ may be hung opened along the hooking periphery HP when taut on the bag support 56. As shown, the cross-sectional area CA has a peripheral outline that is smaller than that of the hooking periphery HP, considering the wall thickness T of the bag support 56. This is so because the hooking periphery HP defined by the bag support 56 is radially outward of the peripheral outline of the cross-sectional area CA. Bag 20′ compatibility with the disposal unit and bag support 56, and installation thereon will be further described herein below. While FIG. 4 shows the hooking periphery HP with a smooth appearance, the bag support 56 may have hooks, protrusions, or like projecting members to act as catch devices or hooks for the bag 20′, thereby defining the hooking periphery HP that is not smooth or continuous about the bag support 56. For example, a variant of the bag support 56 is shown in FIG. 4A. As shown, the bag support 56 may include a plurality of projecting members 56H, here four of them, spaced apart from each other, about the central opening XX. As shown, the central opening XX has a generally rectangular shape with rounded corners. The projecting members 56H project upwardly and outwardly from respective ones of the rounded corners. The projecting members 56H may be hooks, tongues, or like projections. In the embodiment shown, the projecting members 56H are hooks extending outwardly from their base on the bag support 56. The hooks may have a curved outline, e.g., similar curvature as that of the rounded corners from which the hooks project, but this is optional. Hooks may be curved outwardly, as shown, but this is only one possibility. Hooks may flare outwardly in a straight manner, without being curved, in other cases. The hooking periphery HP is shown as being oblong in shape (i.e., a rectangle with rounded corners), but other shapes are considered. For example, while the side edges of the hooking periphery HP are shown as being straight, they may be concave, considering that the bag 20 hung to the projection members 56H may be stretched only at four corners.

In at least some embodiments, as in FIG. 4A, the open cross-sectional area CA of the central opening XX of the bag support 56 has a maximum width dimension WD and a maximum depth dimension DD normal to the maximum width dimension WD, where the central opening XX is shaped and sized so as to have its cross-sectional area CA having its maximum depth dimension DD at least 70% of that of its maximum width dimension WD (or vice versa), i.e., in the range from 70% to 100% inclusively. These dimensions may be maximum dimensions of the central opening XX in two normal directions and extending in a plane having a central axis of the central opening XX normal thereto (e.g., a plane generally parallel to the ground surface on which the disposal unit 50 stands). Exemplary shapes of the cross-sectional area CA respecting this relationship could be rectangular, obround, squircle, ellipse, square, or round. In some embodiments, the cross-sectional area CA could be sized and shaped so as to have its depth dimension DD equal to (±5%) the width dimension WD.

In at least some embodiments, the hooking periphery HP delimits a cross-sectional area (or “footprint”) in a hooking plane which may be parallel to the cross-sectional area CA of the central opening XX. The cross-sectional area delimited by the hooking periphery HP is in accordance with 1.01CA≤HP≤1.2CA.

Returning to references in FIG. 4, the bag support 56 may have a height H_{S}, an inner circumference or cross dimension C_{S}, an outer circumference or cross dimension C_{O}, also referred to as the outline of the hooking periphery HP, and a wall thickness T. In the embodiment of FIG. 3, in which the bag support 56 is circular with an inner diameter D_{S}, the inner circumference C_{S} is equal to TTD_{S}. The outer circumference C_{O} may be expressed as π(D_{S}+2T). In other embodiments, the disposal unit 50 has two or more hooks acting as bag support 56, such as shown in FIG. 4A. FIG. 4 may also be interpreted as having two elongated straight or curved hooks 56H shown in cross section. Such hooks are also present in the exemplary waste disposal device described in U.S. patent application Ser. No. 17/277,361, the entire content of which is incorporated herein by reference. In embodiments where such hooks 56H are present, the height Hs may be the height Hs of the hooks, taken from a base of the hooks to a protruding end or edge of the hooks. The dimensions Ds, Cs Co (or POL) and T discussed above may correspond respectively to a maximal distance between opposite hooks (Ds), an outline extending along the inner surface (facing inwardly towards the central opening of the bag support 56) and interconnecting ends of the opposite hooks (Cs), an outline measured as a chord length forming a closed loop about the hooks (Co, POL), and the maximal thickness of each hook (T).

A funnel 57 may optionally be located below the bag support 56 in the upstanding orientation of the disposal unit 50, but may also be absent. The funnel 57 has a central opening that may have the same shape as the bag support 56. Therefore, in FIG. 3, the funnel 57 has a frusto-conical shape with a central circular opening have a circumference C_{F} and inner diameter D_{F}. The height of the funnel 57 is shown as being HF. In an embodiment, the funnel 57 is immediately below the bag support 56, whereby a height HT from a top edge of the bag support 56 to the edge of the central opening of the funnel 57 is as follows: H_{T}=H_{F}+H_{S}. In an embodiment, the funnel 57 is spaced apart from the bag support 56, whereby H_{T} may include the spacing value along a vertical axis of the disposal unit 50. The funnel 57 centers waste or like items deposited into the deployed bag, for the bag to remain generally compact when filled. The funnel 57 may therefore facilitate the removal of the filled bag from the top of the disposal unit 50, i.e., by an upward pull of the user, in some embodiments. In embodiments where the disposal unit 50 is as described in U.S. patent application Ser. No. 17/277,361, for instance, the maximal distance between opposite hooks may be greater than that of a central opening defined by the bag support 56 through which the bag extends in the interior volume of the disposal unit 50.

With additional reference to FIG. 3, the inner cavity 55 of the disposal unit 50 extends from the bag support 56 to a bottom of the disposal unit 50. The disposal unit 50 has a waste receiving volume that may accommodate the bag 20′ in a filled condition. Such waste receiving volume extends from the bag support 56 in the inner cavity 55. The waste receiving volume has a heightwise dimension UH extending from a top of the bag support 56 (e.g., a topmost location of the bag support 56, such as a plane in which lie the topmost location(s)) to the bottom of the disposal unit 50. The bottom of the disposal unit 50 may be defined by a surface upon which sits the bag 20′ when it is being filled with waste. Such heightwise dimension UH may be referred to as a “useful height” of the disposal unit 50, in that it is the maximum height dimension of the volume inside the disposal unit 50 that may be occupied by waste accumulated in the bag 20′ when the bag 20′ is supported into the disposal unit 50, in use. In an embodiment, the heightwise dimension UH is between 16 inches and 20 inches. In a particular embodiment, the heightwise dimension UH is 18 inches±1 inches. In some applications, such as in kitchen waste applications, the heightwise dimension UH is selected so as to maximize the volume capacity of the disposal unit 50 and maintain an overall height of the disposal unit 50 lower than standard countertop heights or kitchen cabinets (e.g., 30 inches ±5 inches) so as to maintain a suitable heightwise clearance between the bag support 56 and the cabinet top or countertop, in use. This may be advantageous at least in some typical use cases where the disposal unit 50 may be stored within a kitchen cabinet or under a kitchen counter, for example. For these same reasons, the heightwise dimension UH equates to a substantial proportion of the overall height of the disposal unit 50 (e.g., ≥80% of the overall height of the disposal unit 50). In variant, the length of the bag 20′ (from top to bottom, also referred to as height) is equal to between 1.05UH and 1.25UH, inclusively, to ensure that the bag 20′ can be hooked to the bag support 56 and be seated on a bottom of the disposal unit 50, for the weight of the waste to be supported by the disposal unit 50.

As observed in FIG. 3, the bag dispensing cassette 10 or bag roll 20 are disposed in a bottom of the disposal unit 50. In an embodiment, a connection configuration is provided for the bag dispensing cassette 10 or the bag roll 20 to be retained by the base 51, although the bag dispensing cassette 10 or the bag roll 20 may simply be deposited on the base 51 and remain in the bottom of the disposal unit 50 by gravity. The free end of the bag roll 20 extends upwardly, for the top section 20A of the bag 20′ to be partially folded over the bag support 56. In doing so, the top open end of the bag 20′ is held open, for objects to be dumped into the internal volume ZZ the bag 20′ accessible via the top open end. A remainder of the bag 20′, including middle section 20B and the bottom section 20C, extends into the inner cavity 55 of the disposal unit 50, through the central opening XX of the bag support 56. While the bag 20′ is attached to the bag support 56, it remains connected to the bag roll 20 as shown in FIG. 3, in embodiments where the bag 20′ is part of such a bag roll 20. In embodiments where such a bag dispensing cassette 10 is present, the heightwise dimension UH of the volume inside the disposal unit 50 that may be occupied by waste accumulated in the bag 20′ when the bag 20′ is supported into the disposal unit 50 may be measured from a topmost location of the bag support 56 to a bottommost location within the inner cavity 55 that is unobstructed and above or to the side of the bag dispensing cassette 10 to receive waste.

The bag 20′ is configured to be hung opened to the bag support 56 of the disposal unit 50. Dimensions of the bag 20′ in the unstretched condition and mechanical properties of such bag 20′ are selected so as to ensure that the bag 20′ may be hung to the bag support 56 of the disposal unit 50 disclosed herein, remains hung to the bag support 56 when filled with waste in a reasonable amount, and be easily removable from the disposal unit 50 when packed with waste.

Elastic and/or plastic deformation of the bag 20, 20′, 20″ (herein bag 20) occurs to expand the open cross-sectional area of the top section 20A, as the top section 20A is installed and tautened on the bag support 56 (e.g. partially folded over the bag support 56), as the bag 20 has dimensions smaller than that of the hooking periphery HP, when in the roll, or prior to it being hung to the bag support 56. The elastic and/or plastic deformation may assist in securing the top section 20A of the bag 20′, 20″ to the bag support 56, without additional components (e.g. drawstrings, bands, clips, clamps, etc.). For use in a disposal unit 50 as disclosed herein, for instance, manual stretching with limited hassle (or hassle-free) by a user may be contemplated, i.e., without excessive force and/or assistance from a machine. For example, the top section 20A stretched elastically and/or plastically to gain peripheral dimensions as that of the peripheral outline of the hooking periphery HP of the bag support 56 may provide retention of the bag 20′, 20″ on the bag support 56 when the bag 20′, 20″ is packed with waste (e.g. up to 7 kg of waste) and pulled downward by the waste weight, without tearing.

When the bag 20′ is opened at a maximum, unstretched, open cross-sectional area YY, the open cross-sectional area YY in the top section 20A, and anywhere along the length of the bag 20′ is at most 0.95CA, in at least some embodiments. The top section 20A may be stretched elastically and/or plastically, without tearing, at a given tensile load in a direction transverse to the length of the bag 20′, to gain a stretched condition and expand the open cross-sectional area YY of the bag 20′ at the top section 20A at least equal to that delimited by the hooking periphery HP, without tearing (as shown at FIG. 4). As further described later, the maximum, unstretched, open cross-sectional area YY of the bag 20 and mechanical properties of such bag 20 may be selected based on dimensions and/or shape of the bag support 56 of the disposal unit 50, to allow a proper hooking of the top section 20A on the bag support 56 while controlling/limiting a volume expansion of the bag 20 within the inner cavity 55 of the disposal unit 50 when the bag 20 is packed with waste. The bag support 56 and the bag 20 may be mutually parametrized/adapted so as to form a unified arrangement. Additionally, in at least some embodiments, it is desirable that the bag 20′ be supported at its bottom closed end (i.e., the bag 20′ sits on a bottom surface), even though it is supported at its top open end by the bag support 56. The initial dimensions of the bag 20′ and mechanical properties of the film of the bag 20 may therefore be selected based on dimensions and geometries of the bag support 56 (and funnel 57, if present) and disposal unit 50 so as to require a stretching of the film in the top section 20A of the bag 20, elastically and/or plastically, in a transverse direction, by a load applied manually by a user to the bag 20 to hook it, while the remainder of the bag 20 exhibits negligible or no transverse expansion, elastically and/or plastically, as a result of the waste weight and volume stored therein. Stated differently, the bag 20′ is selected to deform (e.g., plastically, or elastically) and not rip at its top portion, when hooked to the bag support 56, while offering sufficient resistance against deformation in its lower portion when receiving waste therein. By controlling/limiting the volume expansion of the bag 20 in the middle section 20B and/or bottom section 20C, which could be caused by the waste weight, the maximum open cross-sectional area YY of the bag 20′ in these sections 20B, 20C, when packed with waste within a given threshold, may remain at most equal to the open cross-sectional area CA of the central opening XX, or open cross-sectional area of the funnel 57, if present, hence facilitating the upward removal of the packed bag 20′ from the disposal unit 50. In the unstretched condition, the bag 20′ may be said to have a cross-sectional area that is between 0.85CA and 0.99CA, though it may outside this range. Additionally, the bag 20′ is selected to extend longitudinally (i.e., in a heightwise direction of the disposal unit 50) from the bag support 56 (e.g., topmost location of the bag support 56) to a bottom of the waste disposal unit 50, over a distance that is more than the heightwise dimension UH (discussed above), so as to remain supported at its top open end by the bag support 56 (e.g., by folding at least part of the top section 20A of the bag 20′ over the bag support 56) and from underneath when packed with waste. In at least some embodiments, the length L of the bag 20′ is in accordance with 1.05UH≤L≤1.25UH, though it may be outside of this range. The length L of the bag 20′ within this range may ensure that there is a sufficient bag length to hook the top open end of the bag 20′ onto the bag support 56, and have the bottom closed end of the bag 20′ supported from underneath within the inner cavity 55.

In an embodiment, at least the top section 20A has a width WA in a flattened two-fold condition selected so as to have in an unstretched condition its open cross-sectional area YY between 90% and 100% of that of the central opening XX of the bag support 56. In an embodiment, in order for the bag 20′ to remain hung to the bag support 56, the bag 20′ may have a given unstretched transverse flattened two-fold width WA in the top section 20A, expressed as follows: 0.9C_{O}/2≤WA <(C_{O}/2). If the bag is not circular when deployed open, for instance if the bag support 56 is not circular, the bag may comply with the following relation: 0.9 POL/2≤WA <POL/2, where POL is an outline of the hooking periphery HP of the bag support 56 taken at a location where the top section 20A of the bag 20′ is secured to the bag support 56, and where WA is the unstretched transverse flattened two-fold width WA. If the bag support 56 is circular, the bag 20′ will adopt a circular shape when hung to the bag support 56, as in FIG. 3. The diameter D of FIG. 3 at the opening of the bag 20′ in the unstretched condition can be expressed as 0.9 (C_{O}/π)≤D<(C_{O}/π). In at least some embodiments, such location where the outline is measured is at the two or more hooks defined by the bag support 56, as discussed above with respect to FIG. 4, where such outline may be measured as a chord length forming a closed loop about the two or more hooks. The top section 20A may then be stretched elastically (i.e., in an elastic deformation range) and/or plastically (i.e., in a plastic deformation range) without tearing, to expand the open cross-sectional area of the top section 20A and/or its top open end such that the top section 20A may be partially folded over the bag support 56 to secure, by mechanical retention, the top section 20A on the bag support 56. In a variant, the bag 30 must have its top stretched in the plastic deformation range to be hooked onto the bag support 56.

The yield strength, elongation at break and/or tensile strength of the bag 20 may be selected so as to avoid tearing of the bag 20 when the bag 20 is stretched transversely to the peripheral dimensions of the bag support 56 and packed with waste (e.g. up to 7 kg of waste), even though the stretching may cause a plastic deformation of the bag 20 at the bag support 56. For example, in at least some embodiments, a bag, such as bag 20 may be stretched transversely to the peripheral dimensions of the bag support 56 to secure the top section 20A of the bag 20′ to the bag support 56, then packed with at most 4 kg of waste (or packed with such weight before securing the bag 20′) without tearing of the bag 20′ in the top section 20A or other sections of the bag 20′.

A low yield strength of the bag 20′,20″, at least in the top section 20A, in a peripheral direction may allow manual stretching of the bag 20′, 20″ with limited hassle while installing and/or removing the bags on the bag support 56. A high tensile strength of the bag 20′ may limit tearing of the bag 20′ taut on the bag support 56 of a disposal unit, and/or during manual installation of the bag 20′ by a user to expand the top section 20A of the bag 20′ from its unstretched condition to its stretched condition. For similar reasons as above, the elongation at break i.e., permissible elongation until the film breaks, in a direction transverse to the length of the bag 20′ may be such that the film integrity is not impacted to the point where the bag is torn at the top section 20A when stretched at the desired dimension to fit on the bag support 56.

In at least some embodiments, the yield strength, elongation at break and/or tensile strength of the bag 20′ may be uniform (or substantially uniform, i.e., within a 10% margin) along its length L, only in the peripheral direction. Uniformity of the yield strength, elongation at break and/or tensile strength may be multidirectional in at least some other embodiments, e.g., in the peripheral direction and in a longitudinal direction. Measurement of those properties in various sections of the tubular film may be made using standardized test method(s) as set forth in the ASTM standards, as applicable, for instance.

Variants of the bag 20′, 20″ are presented herein below.

In a variant, the tubular film in the top section 20A has an elongation at break greater than that of the middle section 20B. For instance, in an embodiment, the elongation at break of the tubular film in the top section 20A is between 105% and 200% of that of the tubular film in the middle section 20B. Additionally or alternatively, the tubular film in the top section 20A may have a yield strength smaller than that of the middle section 20B. That is, at a given tensile load exerted on the tubular film in the top section 20A, for instance 10 pounds, the top section 20A may stretch, either elastically or plastically without tearing, whereas the middle section 20B may not. For instance, in some cases, the yield strength of the tubular film in the top section 20A is between 50% and 95% of that of the middle section 20B. The difference in yield strength between the top section 20A and the middle section 20B may be selected so as to limit a propensity of undesirably stretching the middle section 20B as the top section 20A is being stretched. Additionally or alternatively, the tubular film in the top section 20A may have an elastic modulus that is smaller than that in the middle section 20B. For instance, in some cases, the elastic modulus of the tubular film in the top section 20A versus in the middle section 20B has a ratio between 3:10 and 9:10, where in some cases the ratio is between 4:10 and 8:10, and where in some cases, the ratio is between 5:10 and 7:10. The elastic modulus of the tubular film in the top section 20A versus in the middle section 20B may be lower than 3:10 in other embodiments. In embodiments where the tubular film, either a section or an entirety thereof, include layers of different materials, the elastic modulus or yield strength is the “compounded” elastic modulus or yield strength of the tubular film including the combined layers of materials. The elongation at break and other properties discussed above may be taken in a circumferential or peripheral direction, transversely to the tubular film length. Measurement of those properties in various sections of the tubular film may be made using standardized test method(s) as set forth in the ASTM standards, as applicable, for instance.

While the top section 20A and the middle section 20B of a certain variant are compared above in difference in properties, the top section 20A may be compared with the bottom section 20C in other variants. In some variants, the comparative properties and values discussed above with respect to top section 20A and middle section 20B may be the same when the top section 20A and the bottom section 20C are considered. For instance, this may occur in embodiments where the middle section 20B and the bottom section 20C have the same composition and/or mechanical properties.

In a variant, the tubular film in the top section 20A and in the middle section 20B, includes a layer of EVOH for the film to form an odor barrier. Indeed, the layer of EVOH may extend in the bottom section 20C to maximize the odor barrier. In some cases, the layer of EVOH may be omitted in the top section 20A but present in the middle section 20B and in the bottom section 20C. When full of waste, the bags, such as bag 20′, may be closed by knotting the top open end of the bag 20′ with the top section 20A remaining above the knot (i.e. top section 20A not in contact with the waste), hence odor control in the top section 20A may be optional, depending on the contemplated use. In a variant, the tubular film in the top section 20A includes LLDPE and the tubular film in the middle section 20B and the bottom section 20C includes HDPE, with or without one or more layers of LLDPE.

In a variant, it may be desired to have only the top section 20A adapted to stretch, or to have the top section 20A substantially more stretchable than the middle section 20B (and/or bottom section 20C), in contrast to having the whole bag 20′, including the middle section 20B and the bottom section 20C to stretch or otherwise deform (elastically or plastically), while packing the bag with waste. Such difference in stretchability, as discussed above, may be obtained by different thicknesses, different materials, different number of layers of materials in one or more sections of the bag, and/or surface treatment applied to selected sections of the tubular film, such as only to the top section 20A, and not to the middle section 20B and/or bottom section 20C for instance.

In variants, the lack of (or limited) elasticity and/or stretchability in the middle section 20B and/or bottom section 20C when filled with waste may facilitate removal of a filled bag by upward pull in spite of the presence of the funnel 57 and closing mechanism (not shown) and/or the opening in the bag support 56 through which waste may pass when disposed of in the bag 20′. Because of the funnel 57, the bags of the roll 20 may have a given unstretched transverse flattened two-fold width WB, expressed as follows: WB≤C_{F}/2. As mentioned above, the middle section 20B may not be stretchable, or substantially less stretchable than the top section 20A. Therefore, even when filled with objects, the bags of the roll 20 may be pulled out of the disposal unit 50 from the top, i.e., through the funnel 57 and bag support 56. In doing so, a subsequent bag in the bag roll 20 is pulled upward and its top end is generally aligned with the bag support 56 when the filled bag exits the disposal unit 50 from the top. The filled bag is detached from the roll of bags 20 once out of the disposal unit 50, and the subsequent bag in the roll 20 is hung to the bag support 56 in the manner shown in FIG. 4. It is to be understood that the bags of the roll 20 may have a middle section 20B with a given unstretched transverse flattened two-fold width WB expressed as follows: WB≤C_{S}/2, in embodiments of the disposal unit 50 without funnel 57. As such, a waste volume per length of tubular film may be maximized for a given disposal unit 50 without funnel 57, for instance.

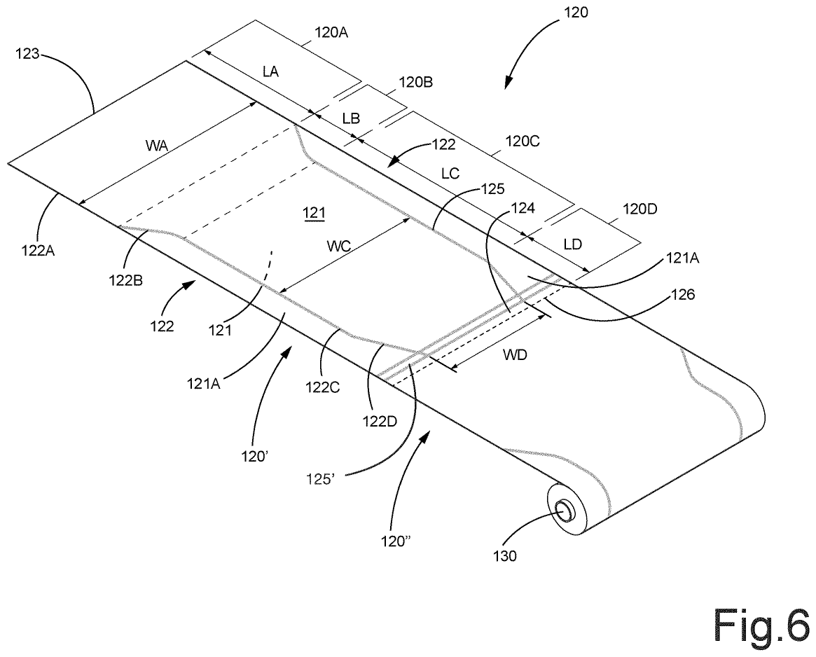

Referring to FIG. 6, another variant of bags on a bag roll 120 for the bag dispensing cassette 10 is generally shown. Features with respect to the tubular film discussed above, including the different properties, such as stretchability elongation at break, yield strength, etc., may similarly apply to the exemplary bag roll of FIG. 6. As shown, the bag roll 120, is rolled onto a tube 130, and may inserted into a cassette body, such as the cassette body 40 of (FIG. 2). The bag roll 120 may also be with or without the tube 130 and/or the cassette body 40. The bag roll 120 may be made of a tubular film of plastic material. For example, depending on the contemplated use, the plastic material may be of plastics such as polyethylene (LDPE, LLDPE or HDPE), bioplastics, polylactic acid, to name a few of numerous possible materials. It is also contemplated to add functional layers to the plastic film, such as ethylene vinyl alcohol, for the film to form an odor barrier, or a nylon layer to reinforce the bag. The film may also be biodegradable and/or compostable material, such as starch-based or plant-based materials.

As shown, and as similarly described with respect to other embodiments, the bag roll 120 may be in the form of a length of tubular film, with weld lines and tear-off perforations delimiting a plurality of bags interconnected end to end, as shown as 120′, 120″ and so on. Any of the bags 120′ may be available on its own and not part of a series or roll of interconnected bags. The tubular film may be accumulated on a roll, in a zig-zag pattern (fanfold) (FIG. 7), multifold, etc. Any of the bag embodiments described herein may be in a roll or in a fanfold, or multifold. The bag roll 120 may consequently appear to be a continuous sheet as in FIG. 6 due to the thinness of the film, though the bag roll 120 has a pair of panels 121 overlaid onto one another, and joined at side edges 122. In an embodiment, this is referred to as a flattened two-fold condition of the bags: the bags have two folds, i.e., one at each side edge 122, and no gusset. The side edges 122 may be folds as the bag may be made of a tubular film. Stated differently, the bag roll 120 may be a continuous tubular length of film, that is flattened and hence defines the side edges 122. Thus, even though a pair of panels 121 is described, the boundary between the panels 121 may be a fold line, forming the side edges 122. Although the bags in the bag roll 120 could have gussets in accordance with the present disclosure, the transverse dimensions of the bag may be described herein as being in the flattened two-fold condition. This may be construed as meaning that, even if the bag roll 120 has gussets, the dimensions are for the transverse dimensions of the bag as if it were in a flattened two-fold condition. Even though the bags described herein may not be packaged or sold in the flattened two-fold condition, the flattened two-fold condition is the condition in which the bags are laid flat on a surface so as to have two lateral folds-two side edges-, between the top edge and the bottom edge.

Moreover, reference is made to the bag as being unstretched. This may be construed as meaning that the bags are in their initial condition on the bag roll 120 prior to having a user handle the bags prior to installing same on a disposal unit, which may entail some elastic deformation or plastic deformation. The bags in their initial condition on the bag roll 120 may have been plastically prestretched in manufacturing, but in spite of such prestretching their condition on the bag roll 120 is said to be unstretched.

The side edges 122 of each bag extend from a top edge 123 to a bottom edge 124 of each bag, such as bag 120′, with weld seams 125. In an embodiment, the side edges 122 are fold lines (i.e., resulting from a panel folded onto itself), though they could be weld seams. In the end-to-end connection of the bag roll 120, the bags are interconnected such that a bottom edge 124 of a leading bag 120′ is connected to a top edge 123 of a trailing bag 120″ in the bag roll 120, in contrast to bag rolls in which bottom edges or top edges of adjacent bags are interconnected. In order to give the side edges 122 the shape described above, the weld seam 125 may be a continuous seam extending from one of the side edges 122 to the other to connect the panels 121 laterally, or may have segments. This continuous seam 125 includes a portion that defines the bottom closed end of the bags 120′, 120″, etc. In the example of FIG. 6, the bottom closed end of the bag 120′, 120″, etc., includes a double seam portion 125′ or segment. As shown, the double seam portion 125′ has two parallel seams extending transversely to the tubular film length. There could be more than two seams, such that a multi-seam portion having more than two seams may be contemplated at the bottom closed end, in some embodiments.

Alternatively, the bags may have separate weld seams 125, i.e., the one(s) for the side edges 122 and the one for the bottom closed end. For simplicity, the expression “weld seams 125” is used in the plural, though a single continuous seam 125 may be present, in a U shape for example. The weld seams 125 may be interpreted as weld seam segments of a continuous weld seam 125. The seam 125 may be created by any appropriate welding or adhering method, such as heat welding, etc, whereby reference is made herein as a weld seam, although other types of jointing is contemplated, such as gluing. The weld seam 125 may also connect the panels 121 to define the bottom edge 124, i.e., the closed bottom end of bags of the bag roll 120. The weld seam 125 may also extend to the top edge 123, although in FIG. 6, the weld seam 125 ends at the larger top section 120A. In the embodiment of FIG. 6, the straight segments 122A of the larger top section 120A are the two folds in the tubular film as described above for the flattened two-fold condition, the folds defining a boundary between the panels 121. Therefore, in accordance with an embodiment, the weld seam 125 is made periodically in a straight continuous tube-a continuous tubular body-in a flattened two-fold condition, and portions of the film laterally outside of the weld seam 125 may be cut out, though they are shown as forming flaps 121A.

When laid flat as in FIG. 6, the bag of the bag roll 120 has a constant width. For example, the side edges 122 are parallel to one another on the full length of the bags from the bag roll 120. However, due to the presence of the weld seams 125, the dimension of the inside of the bag are reduced from the top edge 123 to the bottom edge 124 as described below. On the outside of the seams 125, the bags 120 define flaps 121A that do not form part of the interior of the bag, in that larger objects penetrating the bags 120 cannot fit into the flaps 121A. The side edges 122 are shown as each having an outline that may include a straight segment 122A adjacent to the top edge 123. Then, the weld seams 125 define a tapering segment 122B that may not be present, another straight segment 122C, and/or another tapering segment 122D. The tapering segment 122D extends from the straight segment 122C to the bottom edge 124 of the bags. The segments 122D may be straight lines or curved lines, tapering (i.e., reducing in cross-sectional dimension) from top to bottom. Though the moniker “straight” is used for segment 122C, the side edges may taper, from a maximum dimension of WC, all the way to the bottom edge 124. The expression “straight segment 122C” is used herein for differentiating purposes, in a non-limitative manner. Accordingly, the bags may have four different separate sections, though fewer combinations of separate sections may be present, namely a larger top section 120A, a tapering section 120B, a main storage section 120C and a narrower disposal section 120D, from top to bottom of the bags, such as bag 120′. In an embodiment, the bags are without the tapering section 120B and/or the straight segment 122C, and thus transition directly from the larger top section 120A to the narrower disposal section 120D. The straight segments 122A, although shown as being parallel to one another, may taper toward the bottom edge 124. Likewise, the straight segments 122C, although shown as being parallel to one another, may taper toward the bottom edge 124. As yet another embodiment, the seams 125 defining the side edges 122 may taper continuously from the top edge 123 to the bottom edge 124, at a continuous angle, or with two different angles, i.e., one for section 120A and another for section 120D, with no section 120B or 120C. In another embodiment, the bag 120′ (whether or not part of the roll 120) has the straight segments 122A parallel or quasi-parallel to one another, to then taper beyond the larger top section 120A. For clarity, the width described herein is the flat width as described above, i.e., with the bags of the roll in a flattened two-fold condition with the panels 121 coplanar. The larger top section 120A has a width WA that is greater than a width WC of the main storage section 120C, i.e., WA>WC. Widths WA and WC may be constant throughout most or all of the sections 120A and 120C, respectively, if the segments 122A and 122C are parallel as in FIG. 6. If the segments 122A and 122C taper toward the bottom edge 124, the larger top section 120A has a minimum width WA that is greater than a maximum width WC of the main storage section 120C. For example, the width ratio is as follows: 0.60WA≤WC≤0.95WA. In another embodiment, the width ratio is as follows 0.65 WA≤WC≤0.85WA. In an embodiment, the segments 122A are parallel to one another, whereas the segments 122C taper toward the bottom edge 124 (and may be mirror images of another, with or without curvature (i.e., they may or may not be arcuate). The minimum width WD of the narrower disposal section 120D is less than the width WC of the main storage section 120C as follows: 0.50 WC≤WD≤0.98WC. In an embodiment, WA is equal to 30.0 cm ±6.0 cm, and has length L equal to 77.0 cm+20.0 cm/−20.0 cm.

The bags, such as bag 120, have a length L that may be segmented as LA, LB, LC and LD, to be representative of the height of sections 120A, 120B, 120C and 120D, respectively. In accordance with an embodiment, LC is at least twice the length of LA, i.e., LC>2LA. In accordance with another embodiment including the tapering section 120B, LC is at least twice the length of the combination of LA and LB, i.e., LC>2(LA+LB). LA may be separated into LA1 and LA2 if the top edge 123 defines a concavity or convexity as detailed above with respect to FIGS. 5B-5C. LA2 is the portion of the section 120A below such concavity or convexity. In accordance with an embodiment, LC is at least equal to the length of LD, i.e., LC=LD, but may be at least 10% longer, i.e., LC>1.1LD, or even longer, such as according to the relation LC>3LD. In accordance with an embodiment, 0.30L>LD>0.15L to minimize the reduction in open diameter. As the bag 120 is filled when coming out of a throat of a waste disposal device 10, as shown in the previous figures, the tapering of the bag 120 to the bottom edge 124 facilitates the removal of the bag from the device 10.

The top edge 123 may have different outlines. In FIG. 6, the outline of the top edge 123 is a straight segment. Other outlines are contemplated. As the bags are interconnected end to end in the bag roll 120 with adjacent bags connected bottom to top as described above, the bottom edge 124 has a shape that is complementary to the top edge 123. Stated differently, if the outline of the top edge 123 is a concave sine waveform, the bottom edge 124 is a convex sine waveform, etc.

Tear-off perforation lines 126 are punctured at the junction between the bottom edge 124 of a first bag, the leading bag such as 120′, and the top edge 123 of the subsequent bag in the bag roll 120, the trailing bag such as 120″. The tear-off perforation line 126 may be defined by a series of spaced-apart punctures along an outline emulating that of the bottom edge 123 and the top edge 124. The tear-off perforation line 126 is adjacent to the weld seam 125, and forms a weakened portion of the bag roll 120, causing a separation of one of the bags, as a result of a tearing action. In an embodiment, the tear-off perforation lines 126 and cut outs at the sides of the weld seams 125 are done by die cutting.

It is pointed out that the bag dispensing cassette 10 and/or the bag roll 20, 120 may be used in any other disposal unit, with or without the same components as the disposal unit 50 of FIGS. 3 and 4. The disposal unit 50 is provided as an exemplary bin configuration adapted to be used with the bag dispensing cassette 10 and/or the bag roll 20, 120, yet variants of the disposal unit 50 can be used with the bag dispensing cassette 10 and/or the bag roll 20, 120 as well.

Various aspects of a method for installing and/or using a bag in a waste disposal unit can be drawn from the above description of waste disposal units, bag dispensing cassettes, bag rolls and bags. For example, a user having a waste disposal unit, such as the waste disposal unit 50 described above, may be provided with a bag (20, 20′, 20″), either in the form of a single bag or as part of a bag roll or the like. The user may unroll the bag roll so as to free one of the bags of the bag roll. A closed end of the bag may be positioned in the waste disposal unit 50 by passing a length of the bag through a central opening (XX) of the waste disposal unit 50. The top end of the bag may be deformed from an unstretched condition to hook the bag onto a bag support, such as the various embodiments of the bag support 56, at a top end of the waste disposal unit 50, such that the top end of the bag is open and capable of receiving waste therein. The user may then deposit-immediately after or later in time-waste (or other objects) in the bag via the top open end of the bag. The waste of the bag may be supported by the waste disposal unit 50 via the closed end of the bag being seated against a bottom of the waste disposal unit 50. In at least some cases, the deformation of the bag at the top end to stretch it from the unstretched condition is in the plastic deformation range. The top open end of the bag may be stretch so as to gain open cross-sectional area of its top open end that is at least equal to the hooking periphery HP defined by the bag support 56. The user may, in at least some case, pull the bag transversely so as to expand it, or at least partially open it, and hooking the bag on one hook (56H) at a time, though this is optional. The user may fold the top open end of the bag by partially opening and/or stretching over one or more of the hooks (56H), then further expand and/or stretch the top open end of the bag so as to gain the stretched condition in which the bag may remain hooked on all of the hooks or hooking sections of the bag support 56. Stated differently, deforming the top end of the bag from the unstretched condition may include deforming the bag at separate locations corresponding to separate hooking members of the pail. Other aspects related to the method of use and/or installation of the bag in a waste disposal unit will become apparent from the above description.

1. A bag adapted for use in a waste disposal unit, the waste disposal unit having a bag support for hanging the bag opened, the bag support delimiting a central opening for receiving the bag, the central opening having a cross-sectional area CA, the cross-sectional area CA having a first maximum dimension WD and a second maximum dimension DD normal to the first maximum dimension WD, with DD at least 70% of WD, the bag support defining a hooking periphery HP along the central opening, wherein a peripheral outline of HP is greater than a peripheral outline of CA, and a waste receiving volume having a heightwise dimension UH extending from the bag support to a bottom of the disposal unit, the bag comprising:
a tubular body with a top open end and a bottom closed end, the tubular body of the opened bag defining an internal volume for packing objects,
the tubular body having a first section including the top open end, and at least a second section including the bottom closed end, the first section being stretchable from an unstretched condition to a stretched condition, wherein when the bag is opened:
in the unstretched condition, the first section having an open cross-sectional area smaller than the cross-sectional area CA, and
in the stretched condition, the open cross-sectional area is at least equal to the cross-sectional area CA.

2. The bag of claim 1, wherein the second section has an open cross-sectional area being at most 0.95CA;

3. The bag of claim 1, wherein the tubular body has a length L extending from the top open end to the bottom closed end, the length L greater than the heightwise dimension UH.

4. The bag of claim 3, wherein the length L is in accordance with 1.05UH≤L≤1.25UH.

5. The bag of any one of claim 1, wherein the tubular body in a flattened two-fold condition has a pair of side edges extending from a top edge in a direction of a bottom edge, the top edge delimiting the top open end, the bottom edge delimiting the bottom closed end,
wherein the top open end has a flattened two-fold width WA in accordance with 0.9 POL/2≤WA<POL/2, where POL is defined as an outline of the hooking periphery HP.

6. The bag of claim 5, wherein the side edges are parallel from the top open end to the bottom closed end.

7. The bag of claim wherein the tubular body in a flattened two-fold condition has a pair of side edges extending from a top edge in a direction of a bottom edge, the top edge delimiting the top open end, a weld seam extending from at least one of the side edges to the bottom closed end and forming a taper in the second section, the taper causing a reduction of open cross-sectional area of the bag in the second section.

8. The bag of claim 7, further comprising a flap adjacent to the weld seam, the flap extending between the weld seam and one of the side edges.

9. The bag according to claim 1, wherein the tubular body is made of at least two layers of film.

10. The bag of claim 1, wherein the first section and the second section are made of a film of compostable material.

11.-16. (canceled)

17. The bag of claim 1, wherein the first section is stretchable in a plastic deformation range from the unstretched condition to the stretched condition to gain the cross-sectional area of the top open end at least equal to that delimited by the hooking periphery HP, without tearing.

18. The bag of claim 17, wherein the first section is stretchable in the plastic deformation range to gain, in the stretched condition, a cross-sectional area HPA delimited by the hooking periphery HP in accordance with 1.01CA ≤HPA≤1.2CA.

19. A bag adapted for use in a waste disposal unit, the waste disposal unit having a bag support for hanging the bag opened, the bag support delimiting a central opening for receiving the bag and a hooking periphery HP extending along the central opening, the central opening having a cross-sectional area CA having a first maximum dimension WD and a second maximum dimension DD normal to the first maximum dimension WD, with DD at least 70% of WD, the bag comprising:
a tubular body with a top open end and a bottom closed end, the tubular body of the opened bag defining an internal volume for packing objects, the internal volume reducing longitudinally between the top open end and the bottom closed end;
the tubular body stretchable transversely to expand the top open end, the tubular body having a first section including the top open end, and a second section including the bottom closed end, the first section having a width in a flattened two-fold condition and an elongation at break in a peripheral direction selected so as to have in an unstretched condition an open cross-sectional area between 90% and 100% of the cross-sectional area CA.

20. The bag of claim 19, wherein the waste disposal unit has a waste receiving volume having a heightwise dimension UH extending from the bag support to a bottom of the disposal unit, the bag has a length L extending from the top open end to the bottom closed end, the length L is in accordance with 1.05UH≤L≤1.25UH.

21. The bag of claim 19, wherein the first section is stretchable in a plastic deformation range from the unstretched condition to a stretched condition in which the open cross-sectional area of the top open end is at least equal to that delimited by the hooking periphery HP, without tearing.

22. A bag roll comprising:
a plurality of the bag according to any one of claim 1, wherein the bags are connected end to end and from a bottom edge of a first of the bags in the bag roll, to a top edge of a second of the bags in the bag roll.

23. A bag dispensing cassette comprising a tubular film defining a plurality of bags as defined in any one of claim 1, and a receptacle enclosing at least part of the plurality of bags, the plurality of bags connected end to end and from the bottom edge of a first one of the bags, to the top edge of a second one of the bags, the tubular film accumulated in a fanfold or multifold configuration.

24. A method for installing a bag in a pail, comprising:
positioning a closed end of a bag in a pail through a central opening in the pail;
deforming a top end of the bag from an unstretched condition to hook the bag onto a bag support at a top end of the pail, such that the top end of the bag is open; and
depositing waste in the bag via the top open end, a weight of the waste being supported by the pail via the closed end of the bag being seated against a bottom of the pail.

25. The method according to claim 24, wherein deforming the top end of the bag from the unstretched condition includes deforming the top end of the bag in a plastic deformation range.

26. The method according to claim 24, wherein deforming the top end of the bag from the unstretched condition includes deforming the bag at separate locations corresponding to separate hooking members of the pail.
